(19) United States
(12) Patent Application Publication
(10) Pub. No.: US 2026/0112348 A1
(43) Pub. Date: Apr. 23, 2026

(54) KEYBOARD DEVICE FOR KEYBOARD INSTRUMENT

(71) Applicant: KABUSHIKI KAISHA KAWAI GAKKI SEISAKUSHO, Hamamatsu-shi (JP)

(72) Inventor: Masahiko IWASE, Hamamatsu-shi (JP)

(21) Appl. No.: 19/337,540

(22) Filed: Sep. 23, 2025

(30) Foreign Application Priority Data
Sep. 27, 2024 (JP) 2024-169665

(51) Int. Cl. G10H 1/34

(52) U.S. Cl. CPC G10H 1/346; G10H 2220/221; G10H 2220/265

(57) ABSTRACT

A keyboard device includes a swingable key, an action unit that executes a predetermined operation in conjunction with key depression, a hammer support disposed on a rear side of the key, and a hammer rotatably supported by the hammer support and placed on the action unit. The action unit includes a holder fixed to the rear end of the key, and a repetition lever and a jack rotatably attached to the holder. A jack stopper of the hammer support has an abutment surface that is inclined frontward and downward, and on which the rear end of the jack abuts from below at the time of key depression.

### BACKGROUND

### Technical Field

The present invention relates to a keyboard device for a keyboard instrument such as a digital piano, and particularly relates to a keyboard device for a keyboard instrument that realizes the same action as that of a grand piano.

### Related Art

Conventionally, a keyboard device described in JP 2024-93320 A that has been filed by the present applicant, for example, is known as a keyboard device of this type. The keyboard device includes a key extending in the front-rear direction and swingable with the center in the length direction as a fulcrum, and an action unit that executes a predetermined operation in conjunction with key depression is attached to a rear portion of the key. The action unit includes a holder attached to a key, and a repetition lever and a jack that are rotatably supported by the holder. The repetition lever is formed in a predetermined shape extending in the front-rear direction, and is rotatably supported by the holder through a fitting hole provided in the front portion, and a jack guide hole is provided behind the fitting hole. On the other hand, the jack is rotatably supported by the holder through a fitting hole provided in the lower portion, and includes a hammer push-up portion and a rear arm respectively extending upward and rearward from the fitting hole, and the jack is engaged with the repetition lever in a state where the hammer push-up portion is inserted into the jack guide hole of the repetition lever from below.

Further, a hammer support is disposed on the rear side of the key, and a hammer extending in the front-rear direction is rotatably supported at the rear end thereof by the hammer support. In addition, at the rear portion of the hammer, a hammer protrusion protruding downward is provided, and the hammer protrusion is placed on the upper side of the jack guide hole on an upper surface of the repetition lever.

In the keyboard device configured as described above, upon key depression, the holder at the rear end of the key rises, and the repetition lever and the jack move upward together with the holder. Along with this, first, the repetition lever pushes up the hammer via the hammer protrusion and rotates the hammer upward. Then, the rear end of the repetition lever is locked by abutting against a horizontal repetition stopper of the hammer support from below, so that the jack pushes up the hammer protrusion via the hammer push-up portion to rotate the hammer upward. When the hammer rotates until immediately before pressing a key switch, the rear end of the rear arm of the jack comes into contact with a horizontal jack stopper of the hammer support from below, so that the hammer push-up portion of the jack comes out of the hammer protrusion (escapement). By the escapement of the jack, the hammer is uncoupled from the action unit to press the key switch in a freely rotating state, and thus a piano sound is produced. Here, at the time of escapement of the jack, a click feeling is produced due to a change in touch weight of the key, and a let-off feeling is obtained in a touch feeling when a player plays the keyboard instrument.

### CITATION LIST

### Patent Literature

### Patent Literature 1: JP 2024-93320 A

### SUMMARY

In the keyboard device described above, the following problems may occur due to manufacturing problems. That is, when the action unit is attached to the rear end of the key at the time of manufacturing, the holder may be displaced in the front-rear direction from an appropriate position with respect to the key. For example, in a case where the holder is attached to the rear side of the appropriate position, the rear end of the rear arm of the jack is also located on the rear side accordingly. In this case, the rear end of the rear arm that rises along with key depression rises more quickly and higher. Therefore, the timing at which the rear end of the rear arm abuts on the jack stopper from below becomes earlier, and the subsequent rotating amount of the jack is increased. As a result, the hammer push-up portion of the jack rotates more quickly and further rearward, and the let-off timing at which the hammer escapes from the hammer protrusion comes early, and the reach height of the hammer to be pushed up is lowered.

On the other hand, in a case where the holder is attached to the front side of the appropriate position, contrary to the above case, the timing at which the rear end of the rear arm abuts on the jack stopper from below is delayed, and as a result, the let-off timing is delayed.

As described above, in a case where the attachment position of the holder of the action unit is displaced in the front-rear direction with respect to the appropriate position, there is a possibility that the touch feeling and the sound production timing at the time of key depression are also displaced.

The present invention has been made in order to solve the above problems, and an object of the present invention is to provide a keyboard device for a keyboard instrument capable of ensuring an appropriate operation of an action unit even in a case where attachment of a holder of the action unit attached to a rear end of a key is displaced in a front-rear direction with respect to an appropriate position at the time of manufacturing the keyboard device, and thus a favorable touch feeling and an appropriate sound production timing at the time of key depression may be obtained.

In order to achieve the above object, an invention according to claim 1 includes: a keyboard device for a keyboard instrument, the device including: a key that extends for a predetermined length in a front-rear direction, the key being swingable with a fulcrum being in a vicinity of a center in a length direction; an action unit that is provided in a rear portion of the key and executes a predetermined operation in conjunction with key depression of the key; a hammer support disposed on a rear side of the key; and a hammer that extends for a predetermined length in the front-rear direction, the hammer being rotatably supported at a rear end of the hammer via a hammer shaft that extends in a left-right direction of the hammer support, the hammer being placed on the action unit via a hammer protrusion provided on an immediate front side of the hammer shaft so as to protrude downward, and the hammer being driven upward via the action unit in accordance with key depression of the key, wherein the action unit includes: a holder fixed to a rear end of the key; a repetition lever that is formed in a predetermined shape extending in the front-rear direction, the repetition lever being rotatably attached to the holder, the repetition lever having an upper surface on which the hammer protrusion is placed and which is provided with a jack guide hole penetrating in a vertical direction and extending in the front-rear direction, the repetition lever pushing up the hammer to rotate the hammer upward via the hammer protrusion by being moved up along with key depression of the key; and a jack including a hammer push-up portion extending in the vertical direction and a rear arm extending rearward from a portion near a lower end of the hammer push-up portion, the jack being rotatably attached to the holder, the hammer push-up portion having an upper end inserted into the jack guide hole of the repetition lever from below and engaged with the jack guide hole movably in the front-rear direction, the jack pushing up the hammer to rotate the hammer upward via the hammer protrusion by the hammer push-up portion from a middle of rising of the repetition lever associated with key depression of the key, the hammer support includes a jack stopper that locks the jack as a rear end of the rear arm abuts on the jack stopper from below while the jack pushing up the hammer, and that causes the hammer push-up portion of the jack to be disengaged from the hammer protrusion of the hammer by the jack rotating with the rear end of the rear arm that abut on the jack stopper as a fulcrum, and the jack stopper has an abutment surface that is inclined frontward and downward, the abutment surface allowing the rear end of the rear arm to abut from below.

According to this configuration, the action unit is provided at the rear portion of the key, and the hammer whose rear end is rotatably supported by the hammer shaft of the hammer support is placed on the action unit via the hammer protrusion on the immediate front side of the hammer shaft. The action unit includes the holder fixed to the rear end of the key, and the repetition lever and the jack rotatably attached to the holder. The hammer push-up portion of the jack is inserted into the jack guide hole of the repetition lever from below and movably engaged in the front-rear direction, and the hammer is placed, via the hammer protrusion, on the upper surface of the repetition lever provided with the jack guide hole.

When the front end of the key is pushed down at the time of key depression, the rear end of the key moves upward integrally with the holder of the action unit, and accordingly, the repetition lever of the action unit rises, and the hammer is pushed up and rotated upward via the hammer protrusion. In addition, from the middle of the rising of the repetition lever, the hammer push-up portion of the jack pushes up the hammer via the hammer protrusion and causes the hammer to rotate further upward. Then, during the push-up of the hammer by the jack, the rear end of the rear arm of the jack abuts on the jack stopper of the hammer support from below, and this locks the jack and causes the jack to rotate with the rear end of the rear arm that is in contact as a fulcrum, thereby causing the hammer push-up portion of the jack to be disengaged from the hammer protrusion. That is, the jack is caused to escape from the hammer. By the escapement of the jack, the hammer is disengaged from the action unit and the key, and rotates upward in a free rotating state. At the time of escapement of the jack, a click feeling is generated due to a rapid increase and decrease in the touch weight of the key, and a let-off feeling is obtained with this in the touch feeling of the player who presses the key.

As described above, in the operation of the action unit at the time of key depression, the rear end of the rear arm of the jack abuts on the abutment surface of the jack stopper of the hammer support from below. The abutment surface of the jack stopper is configured to be inclined frontward and downward. In a case where the abutment surface of the jack stopper is configured to be horizontal, when the holder of the action unit to be attached to the rear end of the key is attached to the rear side of the appropriate position at the time of manufacturing the keyboard device, the timing at which the rear end of the rear arm of the jack abuts on the abutment surface of the jack stopper becomes earlier, and conversely, when the holder is attached to the front side of the appropriate position, this timing becomes later. Therefore, according to the present invention, since the abutment surface of the jack stopper is configured to be inclined frontward and downward, the rear end of the rear arm of the jack can abut on the abutment surface of the jack stopper at an appropriate timing even in a case where the holder of the action unit attached to the rear end of the key is attached to be displaced in the front-rear direction with respect to the appropriate position at the time of manufacturing the keyboard device, and thus a favorable touch feeling and an appropriate sound production timing at the time of key depression may be obtained.

### BRIEF DESCRIPTION OF DRAWINGS

FIG. 1A is a perspective view illustrating a part of a keyboard device for a digital piano to which a keyboard device according to an embodiment of the present invention is applied, and FIG. 1B is a right side view of the keyboard device;

FIG. 2A is a perspective view illustrating an action unit assembled to a key and a hammer placed on an upper side of the action unit, and FIG. 2B is an exploded perspective view illustrating the key, the action unit, and the hammer;

FIG. 3A is an external perspective view illustrating a hammer support, and FIG. 3B is a perspective view illustrating the hammer support in a partially cutaway state;

FIG. 4A is a front view illustrating the hammer support, and FIG. 4B is a cross-sectional view taken along line A-A;

FIG. 5A is an enlarged perspective view illustrating the hammer and the action unit, in a state where respective components of the action unit are assembled, and FIG. 5B is an exploded perspective view illustrating the respective components of the action unit;

FIG. 6 is a right side view illustrating the hammer;

FIG. 7 is a right side view illustrating a holder;

FIG. 8A is a right side view illustrating a repetition lever, and FIG. 8B is a right side view illustrating a repetition lever according to a modification;

FIG. 9A is a right side view illustrating a jack, and

FIG. 9B is a right side view illustrating a jack according to a modification;

FIG. 10A is an explanatory view illustrating a key-released state for sequentially explaining the operation of the action unit and the hammer when the key is pressed, and

FIG. 10B is an explanatory view illustrating a state in which the repetition lever abuts a repetition stopper when the key is pressed;

FIG. 11A is an explanatory view subsequent to FIG. 10B, illustrating a state in which the jack abuts a jack stopper, and FIG. 11B is an explanatory view illustrating a state in which the jack is disengaged from a hammer protrusion;

FIG. 12A is an explanatory view subsequent to FIG. 11B, illustrating a state in which the hammer abuts a hammer stopper, and FIG. 12B is an explanatory view illustrating a state in which the hammer rebounds from the hammer stopper and abuts a backcheck; and

FIG. 13A is an explanatory view subsequent to FIG. 12B, illustrating a state in which the jack is moved under a hammer protrusion by the slight returning of the pressed key, and FIG. 13B is an explanatory view illustrating a state in which the key returns to the original key-released state.

### DETAILED DESCRIPTION

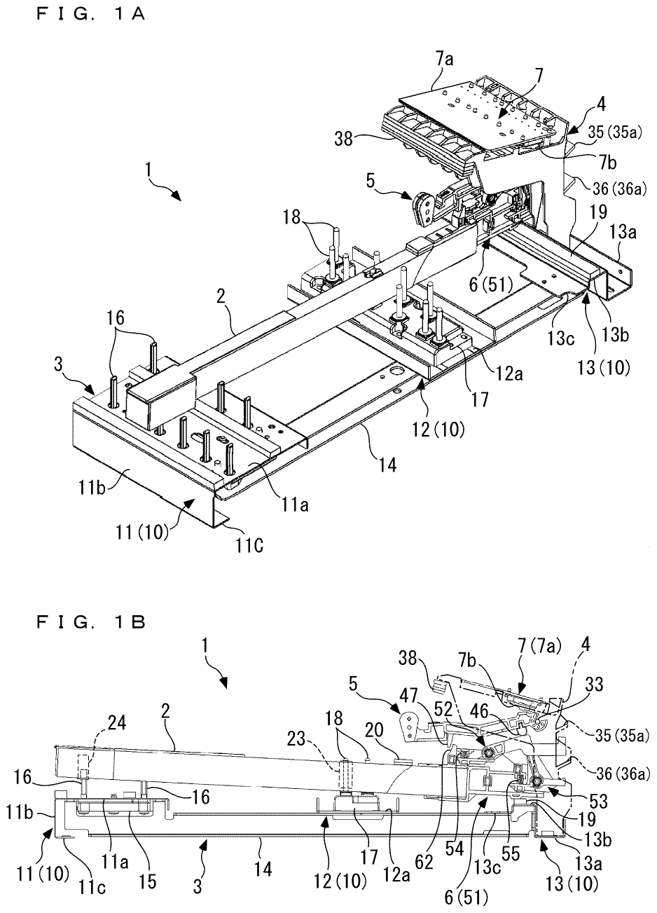

Hereinafter, a preferred embodiment of the present invention will be described in detail with reference to the drawings. FIGS. 1A and 1B illustrate a part of a keyboard device for a digital piano to which a keyboard device according to an embodiment of the present invention is applied in a key release state. FIG. 1A is a perspective view, and FIG. 1B is a right side view.

As illustrated in FIGS. 1A and 1B, a keyboard device 1 includes a large number of keys 2 arranged in a left-right direction of the digital piano (only one white key is illustrated in FIGS. 1A and 1B), a keyboard chassis 3 that supports these keys 2, a hammer support 4 connected to a rear end of the keyboard chassis 3, a hammer 5 provided for each of the keys 2 and rotatably supported by the hammer support 4, an action unit 6 provided at a rear end of the key 2 and driving the hammer 5 upward along with key depression, a key switch 7 for detecting key depression information of the keys 2, and the like.

As illustrated in FIGS. 1A and 1B, the keyboard chassis 3 is formed by assembling three support rails 10 including a front rail 11, a middle rail 12, and a rear rail 13, each of which extends in the left-right direction and disposed at a predetermined interval in the front-rear direction (the left-right direction in FIG. 1B), and a plurality of (for example, five) reinforcement ribs 14 (only one is illustrated in FIGS. 1A and 1B) extending in the front-rear direction and disposed at a predetermined interval in the left-right direction from each other, in a lattice-like shape. The support rails 10 and the ribs 14 are formed of an iron plate formed in a predetermined shape by, for example, press punching and bending, and are connected to each other by screwing.

The front rail 11 includes a horizontal top plate portion 11a, a front plate portion 11b that is bent downward at a right angle from a front end of the top plate portion 11a, and a bottom plate portion 11c that is bent backward at a right angle from a lower end of the front plate portion 11b. A front reed 15 is fixed to a lower surface of the top plate portion 11a by screwing or the like. The front reed 15 is formed in a thick plate shape made of a synthetic resin and extends in the left-right direction over the front rail 11 as a whole. The front reed 15 is provided with a large number of front pins 16 erected in a state of penetrating the top plate portion 11a of the front rail 11 and being aligned in the left-right direction at front and rear positions corresponding to the white key 2 and the black key (not shown).

The middle rail 12 has a horizontal middle reed placement portion 12a, and a front end and a rear end thereof are bent upward at a right angle. To the middle reed placement portion 12a, a middle reed 17 is fixed by screwing or the like in a state where the middle reed is placed. The middle reed 17 is formed in a thick plate shape made of a synthetic resin and extends in the left-right direction over the middle rail 12 as a whole. The middle reed 17 is provided with a large number of balance pins 18 erected in a state of being aligned in the left-right direction at front and rear positions corresponding to the white key 2 and the black key.

The rear rail 13 has an accommodating recess 13a that opens upward and engages with a lower portion of the hammer support 4 in a state of accommodating the lower portion of the hammer support 4, a cushion placement portion 13b that is bent at a right angle from an upper end of a front plate portion of the accommodating recess 13a and horizontally extends forward, and to which a cushion 19 extending in the left-right direction is attached in a placed state, and a connecting portion 13c that is one step downward from a front end of the cushion placement portion 13b and horizontally extends further forward. A plurality of mounting holes penetrating in the front-rear direction are provided in the front plate portion of the accommodating recess 13a, and the lower end of the hammer support 4 is screwed to the rear rail 13 through these mounting holes. The accommodating recess 13a and the connecting portion 13c are screwed to the rear end of each of the ribs 14.

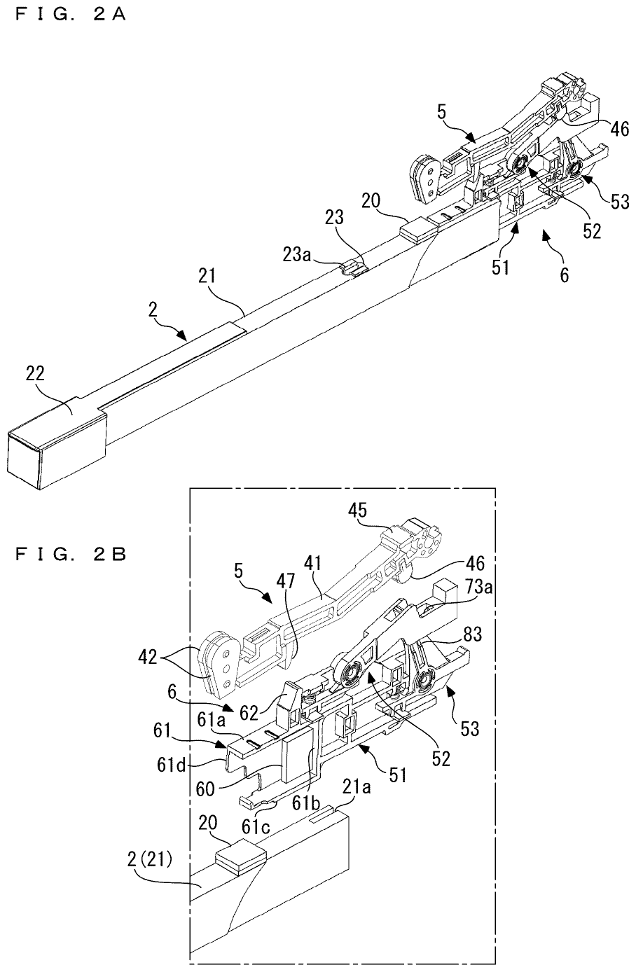

FIG. 2A illustrates the action unit 6 assembled to the key 2 and the hammer 5 placed on an upper side of the action unit 6, and FIG. 2B illustrates the key 2, the action unit 6, and the hammer 5 in an exploded manner. As illustrated in the drawing, the key 2 includes a wooden key body 21 extending by a predetermined length in the front-rear direction and having a rectangular cross section, and a synthetic resin key cover 22 bonded to an upper surface and a front surface of a front half of the key body 21. A balance pin hole 23 penetrating in the vertical direction is provided near the center in the length direction of the key body 21, and the key 2 is swingably supported by the balance pin 18 erected on the middle reed 17 through the balance pin hole 23.

The balance pin hole 23 is formed with a substantially circular hole in the vicinity of the lower surface of the key body 21, and the entire upper portion connected to the hole is formed in a long hole shape extending in the length direction of the key body 21. In addition, pieces of felt 23a are provided on the left and right inner surfaces of the balance pin hole 23 in order to smoothly slide with respect to the balance pin 18 when the key 2 swings. A cushion 20 is bonded to the upper surface of the key body 21 on the rear side of the balance pin hole 23, and the cushion 20 prevents the front end of the hammer 5 from directly hitting the key 2 during maintenance or the like.

In addition, a front pin hole 24 (see FIG. 1B) opened downward is provided at a predetermined position of the front portion of the key body 21, and the front pin hole 24 engaged with a front pin 16 erected on the front reed 15 prevents the key 2 from shaking in the left-right direction when swinging.

Further, as illustrated in FIG. 2B, a guide groove 21a penetrating in the vertical direction and opening rearward is provided at the rear end of the key body 21. The guide groove 21a has a width of a predetermined length in the left-right direction, and is formed to extend by a predetermined length in the front-rear direction in a state of being parallel to a left side surface of the key body 21 in plan view. The guide groove 21a formed in this manner is used to attach a holder 51, which will be described later, of the action unit 6 to the rear end of the key body 21 in an appropriate posture.

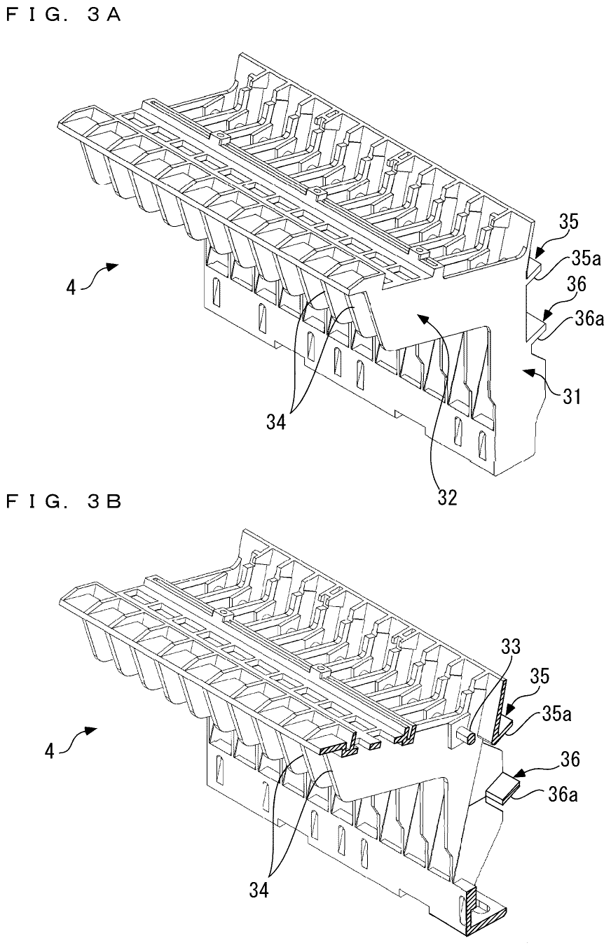

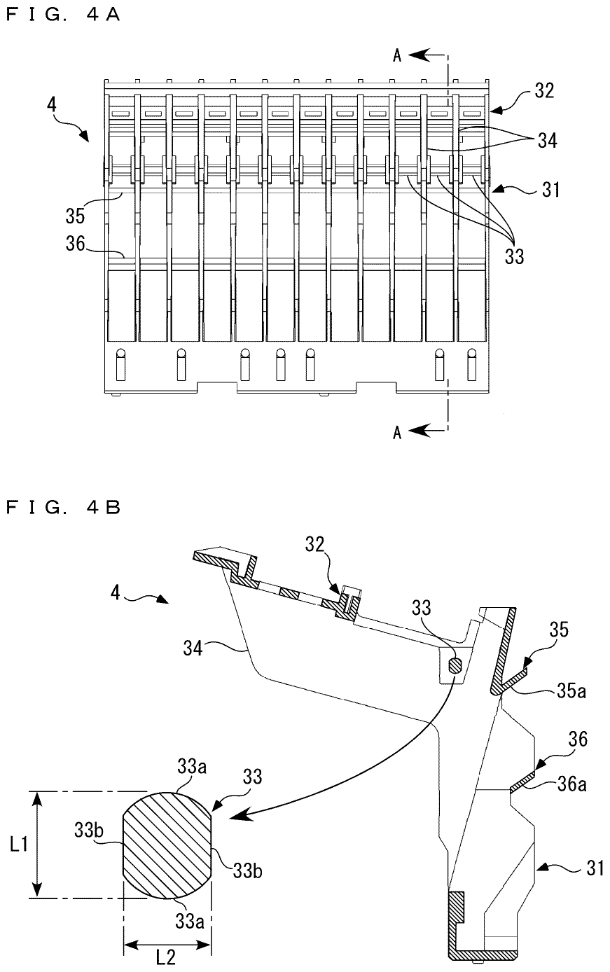

FIGS. 3A and 4A show the hammer support 4. As illustrated in both drawings, the hammer support 4 is formed of a molded product made of a synthetic resin, and is screwed to the rear rail 13 of the keyboard chassis 3 in a state where a plurality of molded products for one octave are connected to each other in the left-right direction, for example. The hammer support 4 includes a hammer supporting portion 31 erecting upright from the vicinity of the rear rail 13, a switch attachment portion 32 extending obliquely upward and forward from an upper end of the hammer supporting portion 31, and the like. Hammer shafts 33 for rotatably supporting the respective hammers 5 are provided at an upper end of the hammer supporting portion 31.

The hammer support 4 has a plurality of partition walls 34 that partition the adjacent hammers 5 at predetermined intervals in the left-right direction, and each of the hammer shafts 33 extends in the left-right direction between the adjacent partition walls 34 and 34. As illustrated in an enlarged manner in FIG. 4B, the hammer shaft 33 has a so-called oval cross-sectional shape in which two portions in front of and behind a circle centered on the axial center of the hammer shaft 33 are cut out.

Specifically, the outer peripheral surface of the hammer shaft 33 includes a pair of upper and lower curved surfaces 33a and 33a and a pair of front and rear flat surfaces 33b and 33b extending between the curved surfaces 33a and 33a. In the hammer shaft 33 configured as described above, the upper and lower curved surfaces 33a, 33a are set in an arc shape having a diameter of a length L1, while a distance between the front and rear flat surfaces 33b, 33b is set to a length L2 shorter than the length L1.

As illustrated in FIGS. 1A and 1B, the key switch 7 is attached to the switch attachment portion 32 of the hammer support 4. The key switch 7 includes a switch substrate 7a made of a printed circuit board, and a switch body 7b made of a rubber switch attached to the switch substrate 7a on a side of the hammer 5 for each of the keys 2.

As shown in FIGS. 3B and 4B, on the back side of the hammer support 4, a repetition stopper 35, on which a repetition lever 52, which will be described later, of the action unit 6 abuts at the time of key depression and which locks the repetition lever 52, is provided below and behind the hammer shaft 33. The repetition stopper 35 has an abutment surface 35a that is inclined frontward and downward and on which the repetition lever 52 abuts. Note that a cushion such as felt may be attached to the abutment surface 35a in order to suppress noise and vibration when the repetition lever 52 abuts.

Furthermore, on the back side of the hammer support 4, a jack stopper 36, on which a jack 53, which will be described later, of the action unit 6 abuts at the time of key depression and which locks the jack 53, is provided below the repetition stopper 35. Similarly to the repetition stopper 35 described above, the jack stopper 36 has an abutment surface 36a that is inclined frontward and downward and on which the jack 53 abuts. Note that a cushion such as felt may also be attached to the abutment surface 36a in order to suppress noise and vibration when the jack 53 abuts.

As shown in FIGS. 1A and 1B, at an upper portion of the front end of the hammer support 4, a hammer stopper 38 on which the hammer 5 abuts from below when the hammer 5 rotates upward, and that prevents the hammer 5 from further rotating is provided.

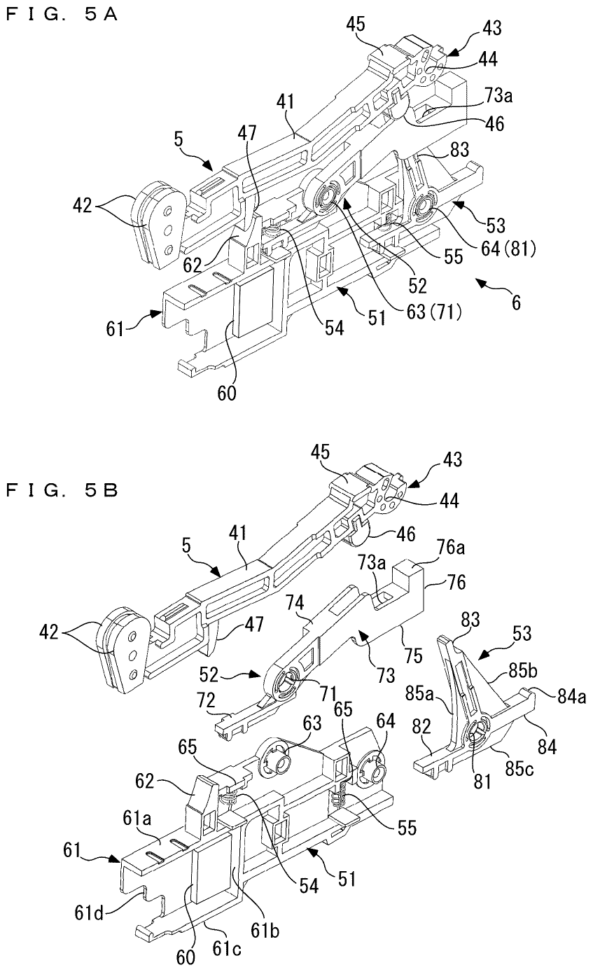

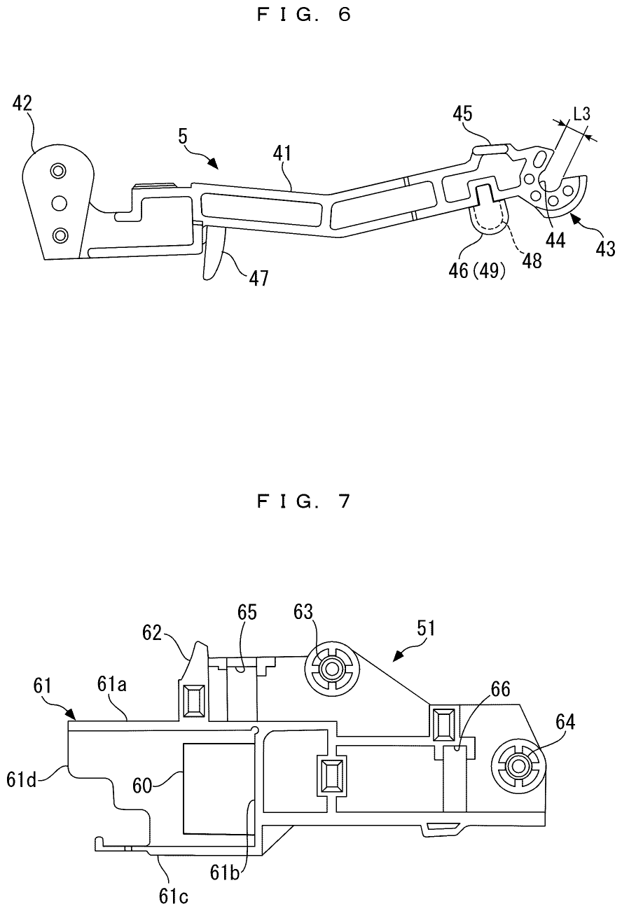

FIGS. 5A and 5B illustrate the hammer 5 and the action unit 6. FIG. 5A illustrates a state in which components of the action unit 6 are assembled, and FIG. 5B illustrates a state in which the components of the action unit 6 are disassembled. Further, FIG. 6 is a right side view illustrating the hammer 5. As illustrated in these drawings, the hammer 5 includes an arm-shaped hammer body 41 extending in the front-rear direction by a predetermined length, and two weight plates 42 and 42 attached to front ends of left and right side surfaces of the hammer body. The hammer body 41 is made of a synthetic resin, and the weight plates 42 are made of a metal material such as iron having a relatively large specific gravity.

At the rear end of the hammer body 41, an engagement portion 43 that engages with the hammer shaft 33 of the hammer support 4 is provided. An arc-shaped shaft hole 44 penetrating in the left-right direction and having a side surface shape in a C shape is provided in the engagement portion 43, and an opening portion of the shaft hole 44 expands outward. The shaft hole 44 has a diameter slightly larger than the diameter (length L1) of the upper and lower curved surfaces 33a, 33a of the hammer shaft 33, and a width L3 of the opening is slightly larger than the length L2 between the front and rear flat surfaces 33b, 33b of hammer shaft 33 and smaller than the length L1. The hammer 5 is detachable from the hammer shaft 33 of the hammer support 4 through the opening of the shaft hole 44, and is rotatably supported by the hammer support 4 by fitting the shaft hole 44 to the hammer shaft 33.

In the rear portion of the hammer 5, a switch pressing portion 45 and a hammer protrusion 46 are provided respectively above and below the immediate front side of the shaft hole 44. The switch pressing portion 45 has a flat upper surface, and presses the switch body 7b of the key switch 7 when the hammer 5 rotates upward, and thus the key depression information of the key 2 corresponding to the hammer 5 is detected.

On the other hand, the hammer protrusion 46 corresponds to a shank roller of a hammer of a grand piano. This hammer protrusion 46 is constituted by attaching a roller bush 49 made of an elastic material to a protrusion body 48 formed integrally with the hammer body 41.

Then, in the key release state, the hammer protrusion 46 is placed on the hammer placement portion 74, which will be described later, of the repetition lever 52 of the action unit 6.

Further, as shown in FIGS. 5A, 5B and 6, at a predetermined position of the front portion of the hammer 5, a backcheck engagement portion 47 which is integrally molded with the hammer body 41 and protrudes downward and can be engaged with a backcheck 62, which will be described later, of the action unit 6 is provided. As illustrated in FIG. 6, the backcheck engagement portion 47 has a vertically long side surface, a flat front surface, and a gentle curved back surface.

Next, the action unit 6 will be described. As illustrated in FIGS. 5A and 5B, the action unit 6 includes the holder 51 fixed to the rear end of the key 2, the repetition lever 52 and the jack 53 rotatably attached to the holder 51, and a repetition spring 54 and a jack spring 55 that respectively bias the repetition lever 52 and the jack 53 to rotate in a predetermined direction and both of which are coil springs.

FIG. 7 shows a right side view of the holder 51. As illustrated in this figure and FIG. 5B, the holder 51 is made of a synthetic resin, and is made of a molded product having a predetermined shape extending in the front-rear direction. The holder 51 includes a key attachment portion 61 provided at the front portion of the holder and fixed to the rear end of the key 2, a backcheck 62 provided above the key attachment portion 61, a repetition shaft 63 provided at the upper end of the holder near the center in the front-rear direction and rotatably supporting the repetition lever 52, and a jack shaft 64 provided at the rear end of the holder and rotatably supporting the jack 53.

The key attachment portion 61 is configured such that side surfaces form a U shape by an upper wall 61a, a rear wall 61b, and a lower wall 61c, and that left ends of these walls are connected by a left side wall 61d. The key attachment portion 61 is provided with a guide rib 60 formed to protrude forward from the rear wall 61b by a predetermined length. The guide rib 60 is formed in a flat plate shape having a predetermined thickness, has a gap between the upper wall 61a and the lower wall 61c, and is disposed in parallel to the left side wall 61d with a predetermined distance therebetween.

In a case where the holder 51 is attached to the rear end of the key 2, the guide rib 60 of the holder 51 is inserted into the guide groove 21a (see FIG. 2B) of the key body 21 from the rear side, and the upper wall 61a and the left side wall 61d of the holder 51 are fixed by bonding in a state of being in contact with the upper surface and the left side surface of the rear end of the key body 21, respectively. In addition, staples (not illustrated) are driven from above the upper wall 61a of the holder 51 and from the left side of the left side wall 61d. Thus, the holder 51 is firmly fixed to the rear end of the key body 21.

The backcheck 62 has a predetermined length in the vertical direction and is formed in a gentle arc shape in a state of facing obliquely upward and forward. The backcheck 62 is configured to lock the backcheck engagement portion 47 of the hammer 5 while slidingly contacting, in a case where the backcheck engagement portion 47 of the hammer 5 is engaged.

Both the repetition shaft 63 and the jack shaft 64 are formed in a cylindrical shape protruding rightward by a predetermined length and having a predetermined diameter. The repetition shaft 63 is formed at a predetermined position higher than a position of the jack shaft 64.

In addition, the holder 51 is provided with a repetition spring locking portion 65 that locks an upper end of the repetition spring 54 at a predetermined position in front of the repetition shaft 63 between the backcheck 62 and the repetition shaft 63. Further, the holder 51 is provided with a jack spring locking portion 66 that locks the upper end of the jack spring 55 at a predetermined position in front of the jack shaft 64 between the repetition shaft 63 and the jack shaft 64.

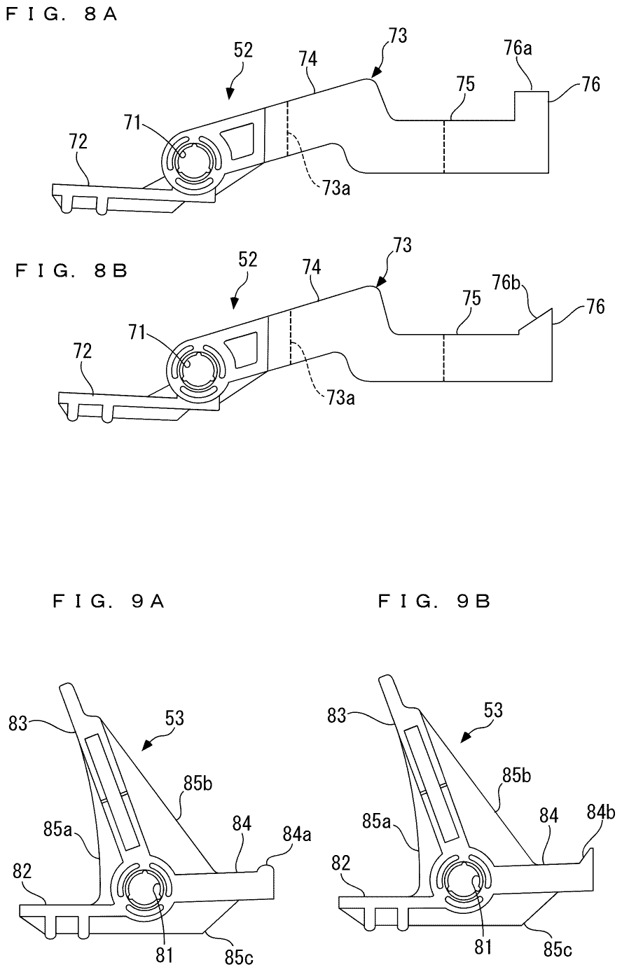

FIG. 8A shows a right side view of the repetition lever 52. As illustrated in FIGS. 8A and 5B, the repetition lever 52 is made of a synthetic resin, and is made of a molded product having a predetermined shape extending in the front-rear direction. The repetition lever 52 includes a fitting hole 71 penetrating in the left-right direction and rotatably fitted to the repetition shaft 63 of the holder 51, a front arm 72 extending forward from the vicinity of the fitting hole 71, and a hammer placement arm 73 that extends backward from the vicinity of the fitting hole 71, on which the hammer 5 is placed, and with which the jack 53 is engaged.

The hammer placement arm 73 of the repetition lever 52 includes a hammer placement portion 74 having a side surface shape extending a predetermined length obliquely upward and rearward from the fitting hole 71, and an extension portion 75 extending obliquely downward and rearward, and further extending rearward, from a rear end of the hammer placement portion 74. In addition, the hammer placement arm 73 is provided with a jack guide hole 73a penetrating in the vertical direction and extending in the front-rear direction across the hammer placement portion 74 and the extension portion 75.

A protruding portion 76 protruding upward is provided at the rear end of the repetition lever 52. When the repetition lever 52 rotates, an upper portion of the protruding portion 76 abuts on the repetition stopper 35, which is described above, from below. Although FIG. 8A illustrates that the upper portion of the protruding portion 76 has a flat surface 76a, as illustrated in FIG. 8B, for example, the upper portion of the protruding portion 76 may be formed to have an inclined surface 76b inclined frontward and downward similarly to the abutment surface 35a of the repetition stopper 35. In this case, when the repetition lever 52 rotates and abuts on the repetition stopper 35, the inclined surface 76b as a whole abuts on the abutment surface 35a.

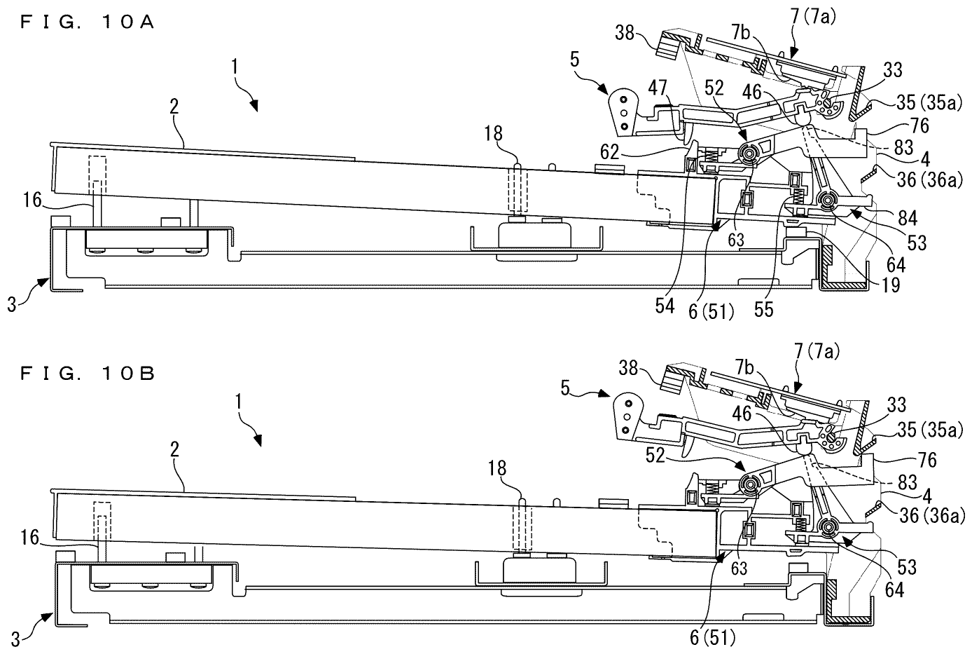

FIG. 9A illustrates a right side view of the jack 53. As illustrated in FIGS. 9A and 5B, the jack 53 is made of a synthetic resin and is formed of a molded product having a predetermined shape. The jack 53 includes a fitting hole 81 penetrating in the left-right direction and rotatably fitted to the jack shaft 64 of the holder 51, a front arm 82 extending forward from the vicinity of the fitting hole 81, a hammer push-up portion 83 extending upward by a predetermined length from the vicinity of the fitting hole 81, and a rear arm 84 extending rearward from the vicinity of the fitting hole 81.

The hammer push-up portion 83 extends obliquely upward and forward in a state inclined forward by a predetermined angle with respect to the front arm 82 and the rear arm 84 extending substantially horizontally in the front-rear direction. In addition, an upper end of the hammer push-up portion 83 is formed to have a smaller width in the front-rear direction than a width at a portion lower than the upper end. A rear end of the rear arm 84 is provided with a protruding portion 84a protruding upward. When the jack 53 rotates, the protruding portion 84a abuts on the jack stopper 36 from below. Note that, although FIG. 9A illustrates that the side surface shape of the protruding portion 84a is formed in an arc shape, as illustrated in FIG. 9B, for example, the rear end of the rear arm 84 may be formed to have an inclined surface 84b inclined frontward and downward similarly to the abutment surface 36a of the jack stopper 36. In this case, when the jack 53 rotates and abuts on the jack stopper 36, the inclined surface 84b as a whole abuts on the abutment surface 36a.

In the jack 53, plate-shaped reinforcing ribs 85a, 85b, and 85c are provided respectively between the front arm 82 and the hammer push-up portion 83, between the hammer push-up portion 83 and the rear arm 84, and between the rear arm 84 and the front arm 82. The strength of the jack 53 is increased by the reinforcing ribs 85a to 85c and the like.

In the action unit 6 formed as described above, as illustrated in FIG. 5A, the hammer push-up portion 83 of the jack 53 is engaged with the jack guide hole 73a of the repetition lever 52 from below in a state of being inserted into the jack guide hole 73a. As illustrated in the drawing, while the front arm 72 of the repetition lever 52 is biased downward by the repetition spring 54, the front arm 82 of the jack 53 is biased downward by the jack spring 55. As a result, the repetition lever 52 and the jack 53 are biased in the counterclockwise direction in FIG. 5A respectively around the repetition shaft 63 and the jack shaft 64.

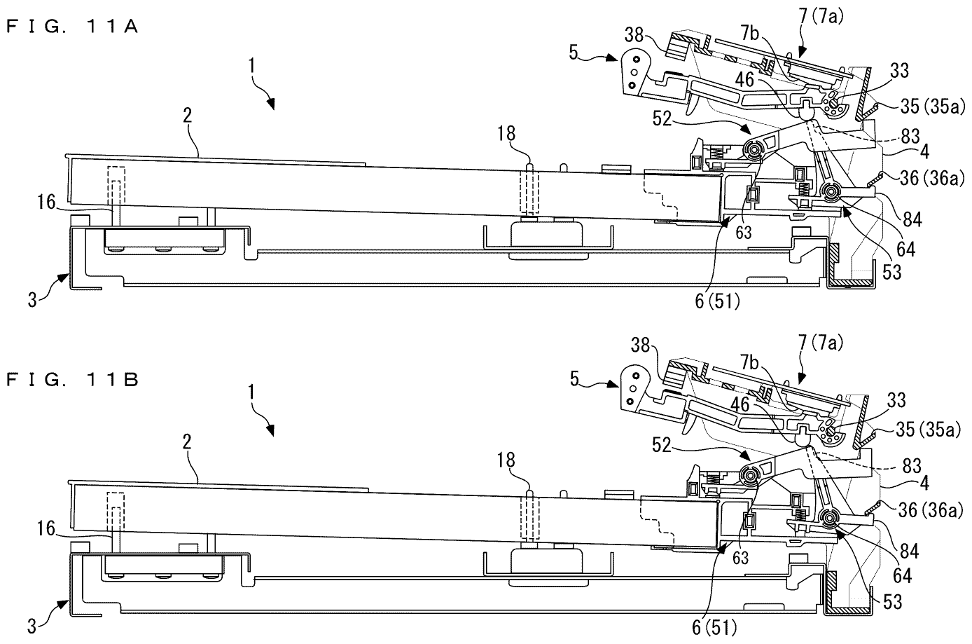

Next, operations of the action unit 6 and the hammer 5 at the time of key depression of the key 2 will be described with reference to FIGS. 10A to 13B.

FIG. 10A illustrates the keyboard device 1 in the key release state. In this key release state, the hammer 5 is placed on the hammer placement portion 74 of the repetition lever 52 via the hammer protrusion 46, and the upper end of the hammer push-up portion 83 of the jack 53 faces the hammer protrusion 46 with a gap therebetween. In the key release state, a gap is provided between the backcheck engagement portion 47 of the hammer 5 and the backcheck 62 of the holder 51.

In the key release state, when the front end of the key 2 is pressed down, the key 2 swings forward and downward about the balance pin 18, and the rear end of the key 2 moves upward. Accordingly, the action unit 6 also moves upward integrally with the rear end of the key 2, and the hammer 5 is pushed up by the repetition lever 52 via the hammer protrusion 46. This causes the hammer 5 to rotate upward (clockwise in FIG. 10A) about the hammer shaft 33.

Next, as the key depression progresses and the action unit 6 moves upward, as illustrated in FIG. 10B, the protruding portion 76 of the rear end of the repetition lever 52 abuts on the abutment surface 35a that is inclined frontward of the repetition stopper 35 in the hammer support 4 from below. As a result, while the rear end of the repetition lever 52 is locked, the upper end of the hammer push-up portion 83 of the jack 53 abuts on the hammer protrusion 46 from below. As a result, the hammer 5 is pushed up by the hammer push-up portion 83 of the jack 53 and further rotates upward.

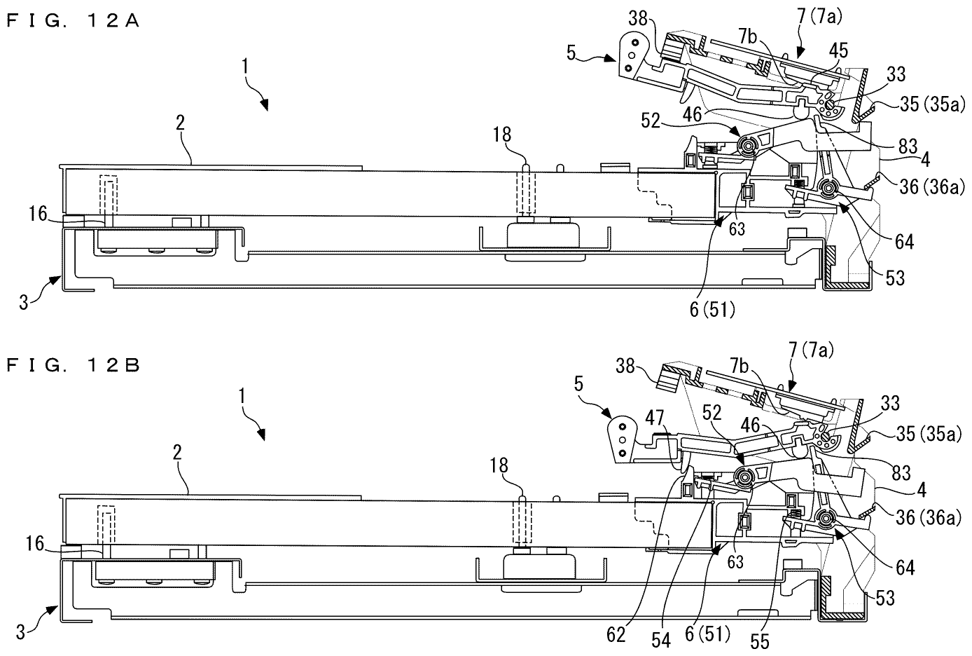

Next, as the key depression further progresses and the action unit 6 further moves upward, as illustrated in FIG. 11A, the protruding portion 84a of the rear end of the rear arm 84 in the jack 53 abuts on the abutment surface 36a that is inclined frontward of the jack stopper 36 in the hammer support 4 from below. Accordingly, by the jack shaft 64 moving upward in a state where the rear end of the rear arm 84 is locked, the jack 53 rotates in the clockwise direction of FIG. 11A with the rear end of the rear arm 84 as a fulcrum. As a result, as illustrated in FIG. 11B, the upper end of the hammer push-up portion 83 of the jack 53 moves backward and comes out of the hammer protrusion 46 of the hammer 5. By the escapement of the jack 53, the hammer 5 is disengaged from the action unit 6 and the key 2, and further rotates upward in the free rotating state.

Note that, at the time of escapement of the jack 53, a click feeling is generated due to a rapid increase and decrease in the touch weight of the key 2, and a let-off feeling is obtained with this in the touch feeling of the player who presses the key.

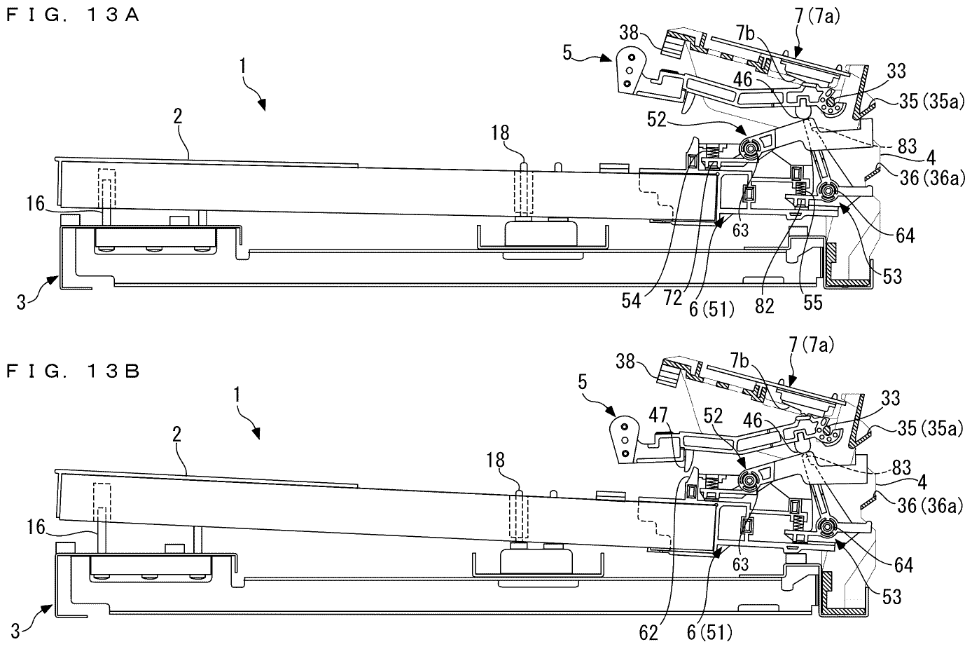

FIG. 12A illustrates a state in which the hammer 5 rotated upward abuts on the hammer stopper 38 at the upper portion of the front end of the hammer support 4. In this case, by the front portion of the hammer body 41 of the hammer 5 abutting on the hammer stopper 38 from below, further rotation of the hammer 5 is prevented. In this case, by the switch pressing portion 45 of the hammer 5 pressing the switch body 7b of the key switch 7 from below to turn on the key switch 7, the key depression information of the key 2 corresponding to a rotating speed of the hammer 5 or the like is detected and output to a sound production control device (not illustrated). Then, the sound production control device outputs a piano sound from a speaker (not illustrated) of the digital piano based on the key depression information.

FIG. 12B illustrates a state immediately after the hammer 5 abuts on the hammer stopper 38, and specifically, a state in which the hammer 5 bounces back from the hammer stopper 38, rotates downward (counterclockwise) toward the original position before key depression, and the backcheck engagement portion 47 of the hammer 5 is locked to the backcheck 62 of the holder 51. In this case, as the backcheck engagement portion 47 is locked with the backcheck 62 in sliding contact, the hammer 5 stops by being prevented from further rotating downward, and rebound and production of vibration of the hammer 5 are prevented.

FIG. 13A illustrates a state in which the depressed key 2 is slightly (for example, ⅓ of the keyboard depth) returned by the key release. Upon key release of the key 2 from the state illustrated in FIG. 12B described above, as illustrated in FIG. 13A, the front end of the key 2 moves upward while the rear end of the key 2 moves downward, and accordingly, the action unit 6 moves downward integrally with the rear end of the key 2. In this case, by the backcheck 62 moving obliquely downward and rearward, the hammer 5 is disengaged from the backcheck 62 and is released from the stopped state. In addition, the front arm 72 of the repetition lever 52 is pushed down by a biasing force of the repetition spring 54, and as a result, the repetition lever 52 rotates in the counterclockwise direction in FIG. 13A about the repetition shaft 63. Similarly, the front arm 82 of the jack 53 is pushed down by a biasing force of the jack spring 55, and as a result, the jack rotates in the counterclockwise direction in FIG. 13A about the jack shaft 64. Accordingly, as illustrated in FIG. 13A, the upper end of the hammer push-up portion 83 of the jack 53 comes around under the hammer protrusion 46 of the hammer 5, and as a result, the hammer 5 can be driven by the action unit 6 even if the key 2 does not completely return to the position in the key release state.

When the key 2 is completely released, as illustrated in FIG. 13B, the key 2, the hammer 5, and the repetition lever 52 and the jack 53 of the action unit 6 return to the original positions in the key release state.

As described above in detail, according to the present embodiment, the keyboard device 1 including the key 2, the action unit 6, and the hammer 5 described above can realize an operation similar to that of a grand piano, whereby a touch feeling and a playing property equivalent to those of the grand piano can be obtained at the time of playing.

Further, in the hammer support 4 of the keyboard device 1, the abutment surfaces 35a and 36a of the repetition stopper 35 and the jack stopper 36, with which the rear ends of the repetition lever 52 of the action unit 6 and the rear arm 84 of the jack 53 abut respectively at the time of key depression, are both inclined frontward and downward. As a result, even when the holder 51 of the action unit 6 to be attached to the rear end of the key 2 is attached to be displaced in the front-rear direction with respect to an appropriate position at the time of manufacturing the keyboard device 1, the rear end of the repetition lever 52 and the rear end of the rear arm 84 of the jack 53 can respectively abut on the abutment surfaces 35a and 36a of the repetition stopper 35 and the jack stopper 36 at appropriate timing. As a result, it is possible to obtain a favorable touch feeling and an appropriate sound production timing at the time of key depression.

Furthermore, in the keyboard device 1, the guide groove 21a is formed in the rear end of the key 2, and the guide rib 60 is provided in the holder 51 of the action unit 6, and therefore, the holder 51 is attached to the rear end of the key 2 in a state where the guide rib 60 is inserted into the guide groove 21a from the rear at the time of manufacturing the keyboard device 1. As a result, the holder 51 is immovable in the left-right direction with respect to the rear end of the key 2 by the left side wall 61d and the guide rib 60. Therefore, even in a case where staples are driven into the holder 51 and attached to the key 2 at the time of manufacturing the keyboard device 1, the holder 51 attached to the key 2 is not attached in a state inclined in the left-right direction, and the holder 51 can be attached in the appropriate posture. Thus, since the holder 51 is attached in the appropriate posture at the time of manufacturing the keyboard device 1, the holder 51 does not come into contact with the hammer support 4 at the time of key depression, and a stable key operation and favorable playing sound can be obtained.

Note that the present invention is not limited to the above-described embodiment, and can be implemented in various modes. The detailed configurations of the keyboard device 1, the key 2, the hammer support 4, the hammer 5, the action unit 6, the holder 51, the repetition lever 52, and the jack 53 described in the embodiment are merely examples, and can be appropriately changed within the scope of the gist of the present invention.

What is claimed is:

1. A keyboard device for a keyboard instrument, the device comprising:
a key that extends for a predetermined length in a front-rear direction, the key being swingable with a fulcrum being in a vicinity of a center in a length direction;
an action unit that is provided in a rear portion of the key and executes a predetermined operation in conjunction with key depression of the key;
a hammer support disposed on a rear side of the key; and
a hammer that extends for a predetermined length in the front-rear direction, the hammer being rotatably supported at a rear end of the hammer via a hammer shaft that extends in a left-right direction of the hammer support, the hammer being placed on the action unit via a hammer protrusion provided on an immediate front side of the hammer shaft so as to protrude downward, and the hammer being driven upward via the action unit in accordance with key depression of the key, wherein the action unit includes:
a holder fixed to a rear end of the key;
a repetition lever that is formed in a predetermined shape extending in the front-rear direction, the repetition lever being rotatably attached to the holder, the repetition lever having an upper surface on which the hammer protrusion is placed and which is provided with a jack guide hole penetrating in a vertical direction and extending in the front-rear direction, the repetition lever pushing up the hammer to rotate the hammer upward via the hammer protrusion by being moved up along with key depression of the key; and
a jack including a hammer push-up portion extending in the vertical direction and a rear arm extending rearward from a portion near a lower end of the hammer push-up portion, the jack being rotatably attached to the holder, the hammer push-up portion having an upper end inserted into the jack guide hole of the repetition lever from below and engaged with the jack guide hole movably in the front-rear direction, the jack pushing up the hammer to rotate the hammer upward via the hammer protrusion by the hammer push-up portion from a middle of rising of the repetition lever associated with key depression of the key, the hammer support includes a jack stopper that locks the jack as a rear end of the rear arm abuts on the jack stopper from below while the jack pushing up the hammer, and that causes the hammer push-up portion of the jack to be disengaged from the hammer protrusion of the hammer by the jack rotating with the rear end of the rear arm that abut on the jack stopper as a fulcrum, and
the jack stopper has an abutment surface that is inclined frontward and downward, the abutment surface allowing the rear end of the rear arm to abut from below.
